(19) United States
(12) Patent Application Publication
(10) Pub. No.: US 2011/0198394 A1
(43) Pub. Date: Aug. 18, 2011

(54) SYSTEM AND METHOD FOR LONG-TERM ARCHIVING OF DIGITAL DATA

(76) Inventors: German Hammerl, Kissing (DE); Jochen Dieter Mannhart, Koenigsbrunn (DE)

(21) Appl. No.: 12/704,667

(22) Filed: Feb. 12, 2010

(51) Int. Cl. G06F 17/00; G06K 7/10

(52) U.S. Cl. 235/375

(57) ABSTRACT

A method and a system for the automated digital archiving of data comprises (1) a writing step in which data are subjected to a first algorithm producing an encoded file which is written into or onto a durable storage medium, preferably with an expected lifetime exceeding 50 years, in a machine-recognizable pattern with a predefined high density and (2) a reading step, in which the storage medium is scanned to obtain an image of the pattern, e.g. a raster graphic of the image, transferring the image to a memory, and storing it therein. Subsequently, by means of pattern recognition, the bits in the data pattern are identified, the value/sequence of these bits determined, and a bit stream for readout produced. The pattern produced in the writing step may encompass two parts, a first part comprising the stored data and a second part, possibly in human readable format, comprising file format information which, in the reading step, is used for identifying the bits and/or decoding the bit stream to derive its content. The writing step may include writing the file as a regular bit pattern onto the durable storage medium using a redundancy and/or an error correction algorithm. It may also comprise applying at least two different first algorithms to the data, thus encoding said data into at least two differently encoded files and writing each of said differently encoded files into or onto the durable storage medium as a regular bit pattern. It may further include writing differently encoded files as at least one regular bit pattern onto the storage medium using redundancy and/or error correction, thus providing a multiple redundancy of the data to be archived.

The invention also concerns an appropriately adapted system including means for creating an encoded file in a self-describing, corruption-safe format, means for writing said encoded file into or onto a storage medium, and second means including means for scanning the medium and locating existing machine-recognizable regular patterns, means for imaging each pattern into a data pattern in a memory, means for analysing the data pattern and identifying bits in said data pattern, and for producing a bit stream as output. The invention further concerns a method for reading or reconstructing data from a data carrier by scanning said data carrier to create an image of said data, producing an image comprising at least a part of said data in a memory, analyzing said image to derive a bit pattern, and reading said bit pattern to generate a bit stream representing said data on said data carrier.

### TECHNICAL FIELD AND BACKGROUND OF THE INVENTION

The present invention provides a system and a method for single-action, long-term archiving of data that can be used by IT laymen working with personal computers. This system requires no hardware other than a computer, a printer, and a scanner or a digital camera. The system allows to archive data with a lifetime of many centuries and may be initiated by a single click of a button. It allows the reading of the stored data in hundreds of years with hardware and software that is available at this time, i.e. without requiring special hardware or software.

Due to the digital revolution, more and more data are collected, generated and stored. As of today, however, the practical archiving of digital data over a time of 50 years and more is an unresolved issue. The problem of archiving digital data comprises four issues:

(1) The lifetime of data stored on standard storage media such as harddisks, magnetic diskettes, CDs, DVDs, USB sticks, magnetooptical discs, and magnetic tapes is generally limited to several decades only. This is because the storage media are subject to decay.

(2) To read these standard storage media, special devices are required, such as DVD-drives or tape readers that commonly become unavailable after several decades. Both, the long-term availability of the drive and of the controller, are problematic.

(3) Commonly, data are stored in file formats whose reading requires compatible software. An example is the file format of the formerly widely used graphics software “Freelance” that cannot be read any more with most of today's software packages. To read some file formats, even compatible operating systems are often required which again require compatible hardware. As software packages and operating systems evolve over time, accessibility to the original software packages and operating systems deteriorates, and after several decades many files cannot be read anymore.

(4) Many file formats used today present the data as bit strings or streams; such strings or streams may become unreadable in completeness if only a few bits are corrupted.

Present practices to store data over long time periods include:

(a) copying of digital data on new data carriers on a regular basis, including migrating the data to new file formats;

(b) archiving data on special media such as microfilm and storage of the media in especially protected environments such as mines; or

(c) storage of data by a provider on the internet.

Practices (a) and (b) are cumbersome and costly and usually not available to standard consumers. For practice (c), the data have to be given to third persons whom need to be trusted to store the data safely and securely over long times. Together with costs associated with such a storage, these issues make practice (c) unattractive in many cases, especially for privateers. It has been estimated by the International Data Corporation, however, that by 2010 nearly 70% of the digital universe will be created by individuals rather than organizations (Ref. Nature, see below). Therefore, a practical archiving system is needed that allows standard consumers to reliably and conveniently store digital data safely for long periods.

Listed below are some papers and articles discussing the above issues:
J. Leighton John, “The future of saving our past”, Nature 459, 775 (2009)
J. Rothenberg, “Avoiding Technological Quicksand: Finding a Viable Technical Foundation for Digital Preservation”, Council on Library and Information Resources, January 1999; http://www.clir.org/pubs/reports/rothenberg/contents.html;
C. Diaconu, D. South, “Study Group Considers How to Preserve Data”, CERN Courier, May 2001, pp 21;
Kenneth Thibodeau, “Preservation and Migration of Electronic Records: The State of the Issue”, The U.S. National Archives & Records Administration, Jul. 24, 2007; http://www.archives.gov;
J. JaJa et al., “Digital Archiving and Long Term Preservation: An Early Experience with Grid and Digital Library Technologies”, The U.S. National Archives & Records Administration, Jul. 24, 2007; http://www.archives.gov;

The term “format” is used hereinbelow as meaning “file format” which describes how the data is organized and encoded. Many file formats use a publicly available specification, e.g. HTML or XML, but there are also formats whose specification is not published. Often, the format is defined only implicitly, but recognized by the program that manipulates the data. Generally, file formats with publicly available specifications are supported by a large number of programs, while non-public formats are supported by only a few programs.

There are two ways to identify the format of a file. A first way, used in many of today's standard operating systems, is to determine the format based on the “filename extension”, i.e. the part of the filename following the final period. For example, HTML documents are identified by names that end with “html” or “htm”.

A second way to identify a file format is to store format information within the file itself as internal metadata. Usually, such information is written in one or more binary string(s), tagged to a predefined location within the file. Also raw texts placed in a fixed location may be used. Obviously, the most easily identifiable location is the beginning of the file; this area is usually called a “file header” which is few bytes long.

Text files may have character-based human-readable headers, whereas binary formats usually feature binary headers. Mostly, a human-readable file header may require more bytes, but is easily recognizable.

While special file standards are developed for longterm storage, for formatting data for archiving the opposite method is far more advantageous. Instead of using a special, unique standard, the disclosed invention provides a method whereby the data are stored on the storage medium with as little restriction on the storage standard as possible, but such that the format of the stored data can be recognized by pattern recognition. To achieve this goal, data formats are used which can easily be inferred from an image of the stored data, possibly by a completely automated process. To facilitate the identification of the data format used, information about the data format may be added to the data as metadata as explained above, preferably in a format different from the data format to render it easily machine-recognizable. An example for such a data format are unicode letters.

Also, the data storage medium used by this invention fulfills the requirements for long-term archiving.

In a first realization the invention may use standard or special coated paper or comparable foils, for example plastic ones, as a storage medium. As widely accepted, paper is one of the few materials which can carry information for a very long period of time without degrading. Using paper as a storage medium is thus applicable for long term archiving processes. Further, paper is an inexpensive storage medium and available everywhere in many qualities. With the use of paper one is able to use the archival system with standard hardware.

In another realization of the invention, also magnetic storage media are possible which will not degrade significantly over time; an example will be shown further down. As, in implementing the present invention, media are used as “write once, read many” media, no great demands exists on the switching times of the bits, therefore allowing well known magnetic materials to store information for a long period of time.

With the invention, hundreds of written text pages can be compressed and printed on a single, machine-recognizable page. Thus, the contents of hundreds of folders can be compressed into a single folder, providing significant gains of shelf space without any reduction of data lifetime. Due to the high compression ratio, multiple copies can be printed that can easily be stored in different places, thus reducing the risk of data loss.

An intrinsic advantage of the disclosed invention is that the data are archived digitally, not just as clear, readable text. The use of a digital format is preferable, first of all, because it directly matches the digital character of the data. Further, it allows for a substantial higher storage density. With the simple use of paper, the storage density can readily be 400 times the storage density of printed, human-readable print on paper. If magnetic storage carriers are used, the density will be much higher. In addition, and as important, the digital format allows the implementation of optimized methods of error correction, so that, for example, the redundancy and therefore the longevity of the data can easily be chosen as desired without requiring excessive storage capacity.

A further advantage is that the method according to the invention can be implemented by software on practically any standard computer, independent of the operating system used, and requires, in one implementation, just a standard printer to produce a long-term archive. For the reading process, in this case any standard scanner can be used. It is forseeable that computers, printers and scanners will be available in the future as they are today—independent of any particular computer or printer or scanner technology, operating systems, or other future, still unknown developments. Furthermore, computers will also get faster and scanning devices will have higher resolutions in the future therefore increasing the probability that the stored information can be read in contrast to today's storage media, where the probability is decreasing with time.

These objects and advantages are achieved by the present invention which is described in the following in general and by means of several exemplary implementations.

### SUMMARY OF THE INVENTION

In brief, the present invention provides a method for format-free, long-term archiving of digital data using pattern recognition techniques; it comprises a writing step and a reading step.

In the writing step, the data to be archived are identified manually or automatically, a first algorithm is applied to these data, said algorithm encoding the data into a formatted or encoded file, preferably with a self-describing, corruption-safe format. This encoded file is stored on or in a durable storage medium, preferably with a lifetime exceeding 50 years, in a machine-recognizable, regularly arranged pattern with a predefined density at least locally exceeding 5 kB/cm². The most economical way is to print such a pattern onto a sheet of durable paper, but magnetic storage media or phase change materials are also possible.

In one implementation, the pattern includes two parts, a first part comprising the encoded data and a second part as file format information describing the format of the stored data. The second part may be stored differently from the first part in or on the same storage medium, but it may also be stored as internal metadata as defined above.

The reading step uses an automated process in which the whole or at least a part of the storage medium is scanned to obtain an image of the stored data pattern, which is then at least partially stored in a memory. This stored image should preferably comprise the information of at least ten bits of the data pattern. The image is then analysed by a second algorithm, usually a pattern recognition algorithm, to reveal the data pattern and to identify the bits in said data pattern and their sequence, producing a bitstream. In a second step, with said pattern recognition algorithm the stored file format is reconstructed from the image. Applying said identified file format information to the bit stream, the archived data can finally be decoded.

### BRIEF DESCRIPTION OF THE DRAWINGS

FIG. 1 shows a principle overview of a sample arrangement for executing the writing step according to the invention;

FIG. 2 exhibits, in a similar way as FIG. 1, an arrangement for executing the reading step according to the invention;

FIG. 3 displays a sample of stored data as dot patterns printed on a sheet in a first configuration of arrays;

FIG. 4 is the sample of FIG. 3 enlarged to show the details;

FIG. 5 is a second sample of stored data as printed dot patterns in a second configuration of arrays;

FIG. 6 depicts a third sample of stored data as printed dot patterns in a third configuration of arrays;

FIGS. 7a to 7c show screenshots of scanned and decoded dot patterns using a pattern recognition algorithm;

FIGS. 8a and 8b shows a flow diagram showing the principle with variations of an archiving method according to the invention;

FIG. 9 illustrates a cross section of a special data carrier, so-called “hardsheet”, used for archiving data according to the invention;

FIG. 10 depicts data arrays on a “hardsheet” as shown in FIG. 9.

### DETAILED DESCRIPTION OF THE INVENTION

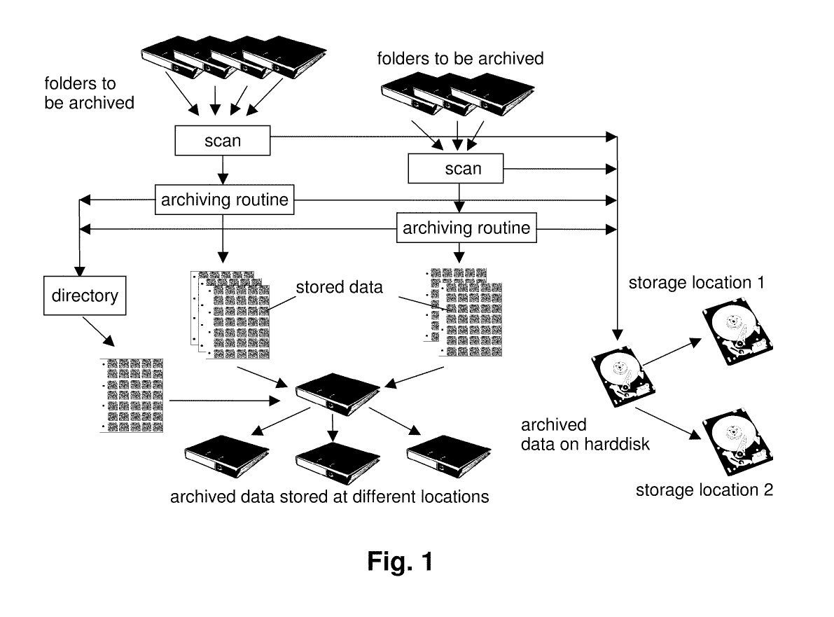

FIG. 1 is a general overview of a sample arrangement for executing the writing step according to the invention using paper as storage medium. The objective is to archive the contents of a plurality of folders shown on top of the figure. The many pages of the documents in these folders are scanned and subjected to the archiving routine which will be explained in detail further down. The output of this routine is a digital bit stream which is on one hand written onto a number of hard disks and, practically at the same time, printed as dot patterns onto data carriers like simple and inexpensive paper sheets. These are then collected and several copies deposited at different locations. The archiving routine also produces a directory or a number of directories which are stored together with the archived data at different locations. Of course, instead of scanned pages, digital data such as files can be archived by the archiving routine as well.

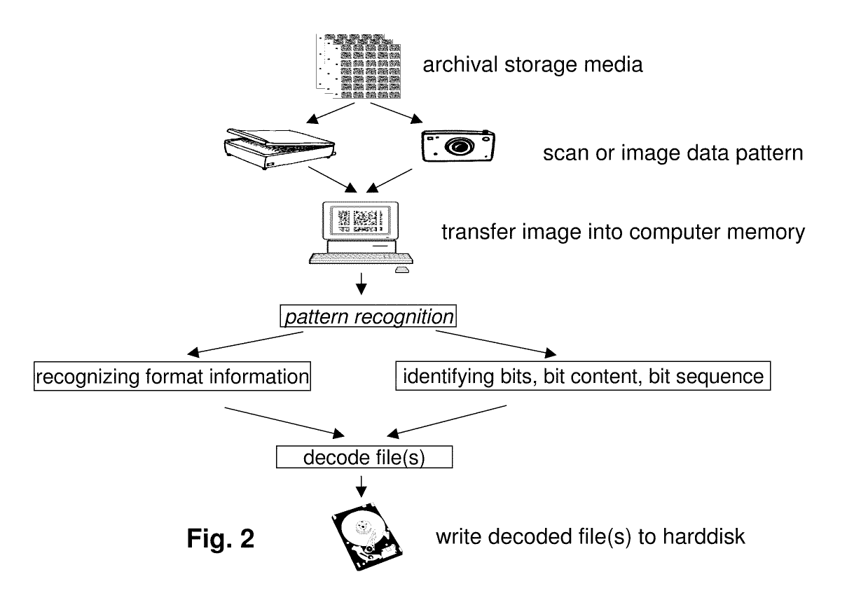

FIG. 2 shows a general overview of the complementary reading process. The reading process starts by at least partially imaging one or more storage media and storing the image or images in a memory. The stored data pattern is then recognized by an algorithm and the bits, their values and their sequence are revealed. By reading the file format in a similar process the original data can be restored by applying said file format to the bit stream.

Now assume that, after many, many decades, the archived data have to be accessed. As described above, the problem is that the software and/or the hardware necessary to read the magnetic harddisks is—or may be—no more available. This is already today the case when someone wants to read old 5.25-inch or 8-inch magnetic diskettes, so-called floppies, which are not even 30 years old. Thus the “classical” approach to obtain data stored on magnetic disks or similar data carriers will almost certainly fail after, say, a hundred years.

The reading of a printed archive is much simpler since optical scanning is a process that can be executed by any scanner with adequate resolution; there is no particular adaptation of the scanner to the document necessary. Any of today's scanners can read a document that is 500 years old. Even documents that are much older have been scanned and are accessible today through the Internet.

The novel approach of the present invention includes, but is not limited to, producing a digital image of the stored data, e.g. a raster graphic, in a memory. Especially from a printed archive, this task needs only standard equipment, i.e. equipment that does not have to be adapted to format or technology of the archived data. But even from magnetic or other data carriers, it will always be possible to obtain an image in a computer memory. Take for example one of those 8-inch floppies mentioned above. With a magnetic scanner, producing an image of the floppy in a memory is a rather simple task. Please note that this scanning does not “read” the data from the floppy, but just produces a digital image in a memory. The meaning of the data is still unknown—it is not even clear whether the data have any meaning. Please note also, that because only an image is produced, the scanning works also if the file format is unknown or the file is corrupted. This is not the case for reading data from standard memory devices. If a CD or a harddisk has a scratch, e.g., the data of the whole data carrier may be unreadable.

This digital image in the computer memory is then subjected to recognition processes described in detail further down.

So much with regard to the method for the automated digital archiving of data according to the invention in general. In the following, some more detailed implementations are described in connection with the appended drawings.

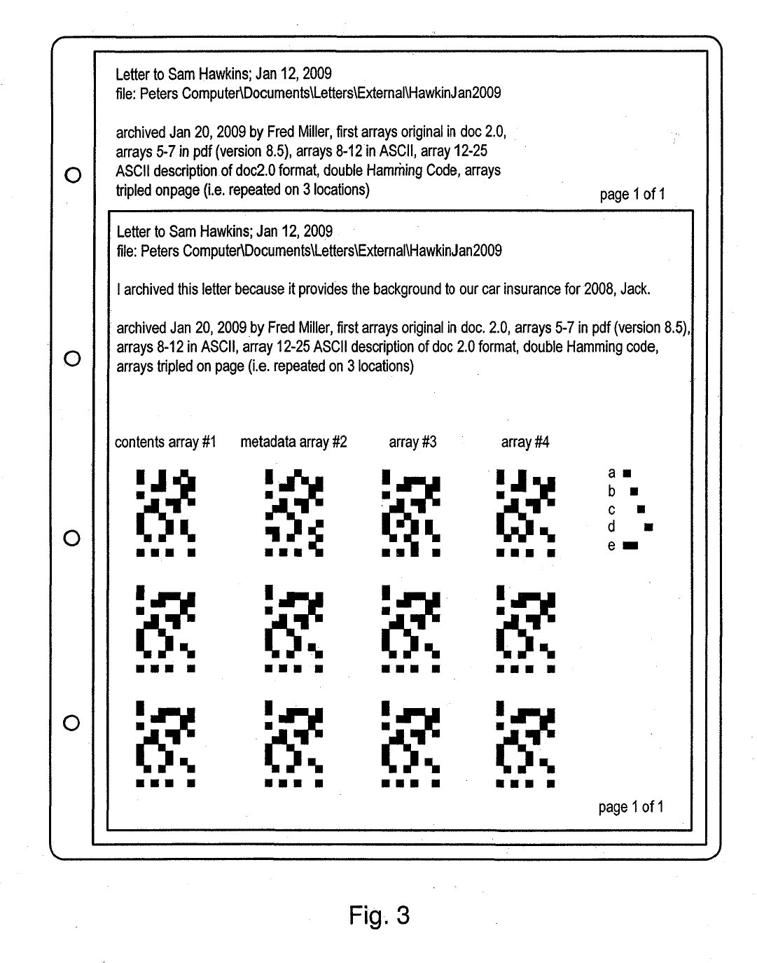

FIG. 3 shows a sample sketch of a printed sheet with stored data, see also FIG. 1. This sheet contains some clear text and a number of patterns which are machine-recognizable, regularly arranged dot patterns with some predefined density. The latter may vary depending on the needs and/or the quality of the data carrier. The arrays are sketched in low resolution. In reality, the dot pattern will show a much higher resolution with dot densities in the range of several kb/cm².

The sheet is a first exemplary embodiment of a durable storage medium containing digitally archived data being stored compressed in a machine-readable manner. The data are digitized images of a number of documents, the characters therein being encoded with a first algorithm. The images are downsized and stored in high density onto the storage medium. The sheet is of paper or plastic material and the images are written by means of a printer on it. The stored images are printed close to each other in several dot-arrays, each with a plurality of dots or pixels. The dots are preferably of the same size and in the example shown of two different colours. The sheet contains a sequence of dot arrays and pictures either of a single page of the archived document, or multiple pages of a document, or several documents depending on the size of the dots used. To avoid printing or reading errors, the dot arrays are printed threefold on the medium, thus providing a redundancy of the archived data. Each of the dot arrays may have two ore more dot subarrays.

The paper or plastic storage medium of FIG. 3 contains as a first array a table of contents of the storage medium. In this table, the documents archived on the sheet may be listed among other things. As a second array, so-called metadata are stored on the medium, said metadata containing information concerning the storage medium and/or the documents archived on it. The following dot arrays comprise the archived documents in a binary coded form. Also, the sheet includes a transformation table, visible at the right, showing which dot or pixel sequence is associated with the original characters used within the stored documents. Moreover the sheet comprises a header section identifying the storage medium in plain language and giving some additional information, e.g. pertaining to the intention of the archiving and/or the content of the archived data in cleartext.

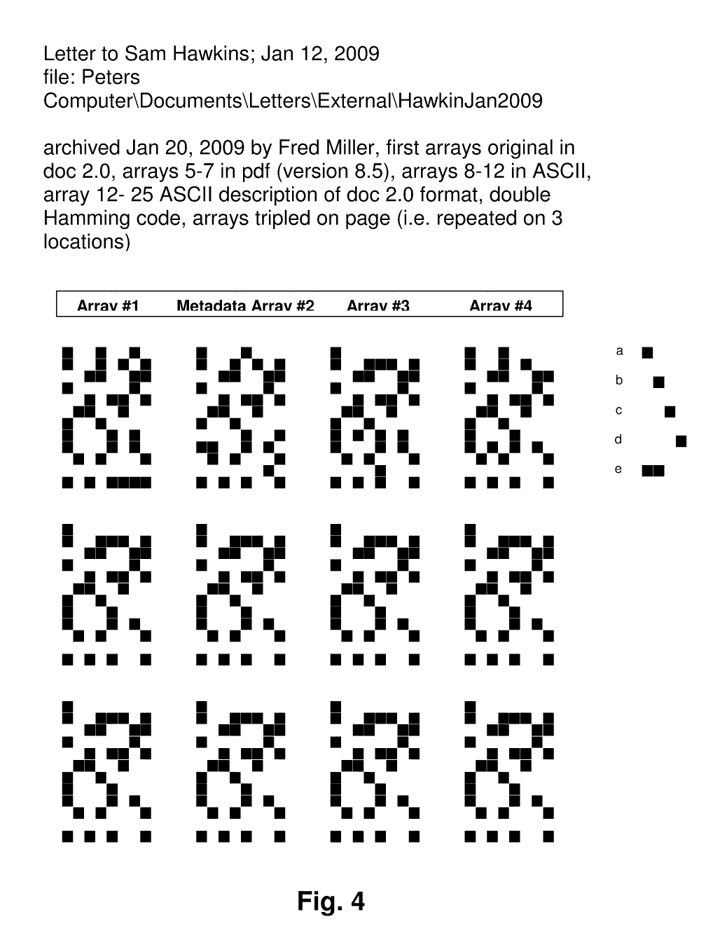

FIG. 4 is essentially the same picture but in an enlarged version. The cleartext on top is some information on the contents of the archived text below. The arrays are again sketched in low resolution. In reality, the dot pattern will show a much higher resolution with dot densities in the range of several kb/cm².

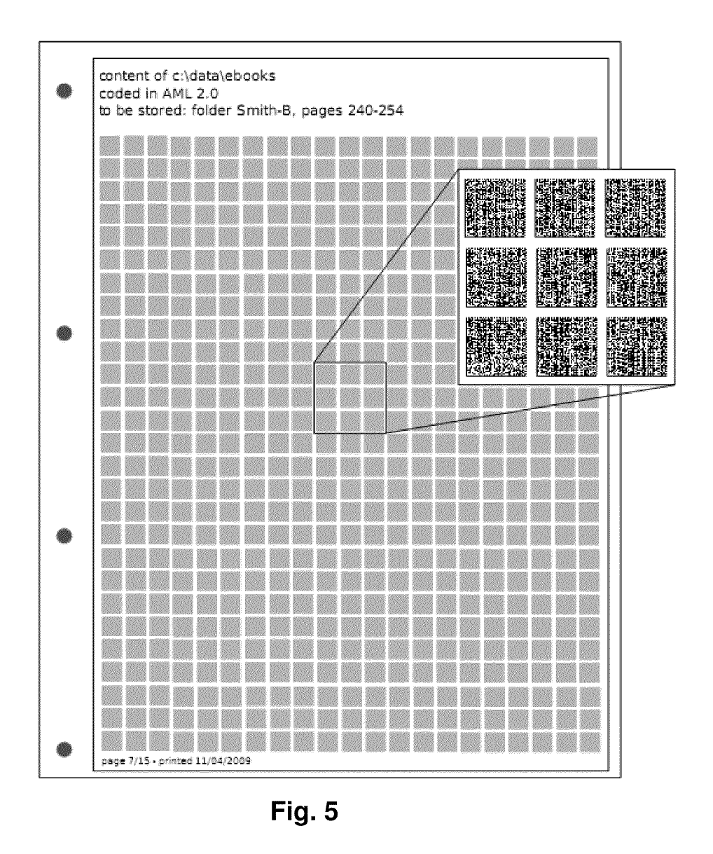

FIG. 5 is a second sample of stored data as printed dot patterns in another configuration. Here the cleartext on top defines the contents of the archived data below and the place where this page is to be stored. The cleartext at the bottom of the page may contain further human readable data, e.g. place, time, and date of archiving, name or initials of the author of the data and/or of the archivist.

The enlarged dot patterns are shown as proof-of-principle and consist of ascii text in its 8 bit representation with 4 bit error correction.

When writing, the two-dimensional data code can be printed simply and with rather high optical definition on the storage medium with a standard printer, whereby pixel or dot sizes of 0.1 mm and below are possible.

In the reading step, the information of the subarrays can easily be read by a common scanner or camera and can be made available converted into electrical information. Such information usually has a digital format, i.e. is a bit sequence, and can be stored with suitable software in an electronic read/write memory. This memory then contains an electronic image of the arrays and/or subarrays on the storage medium described above.

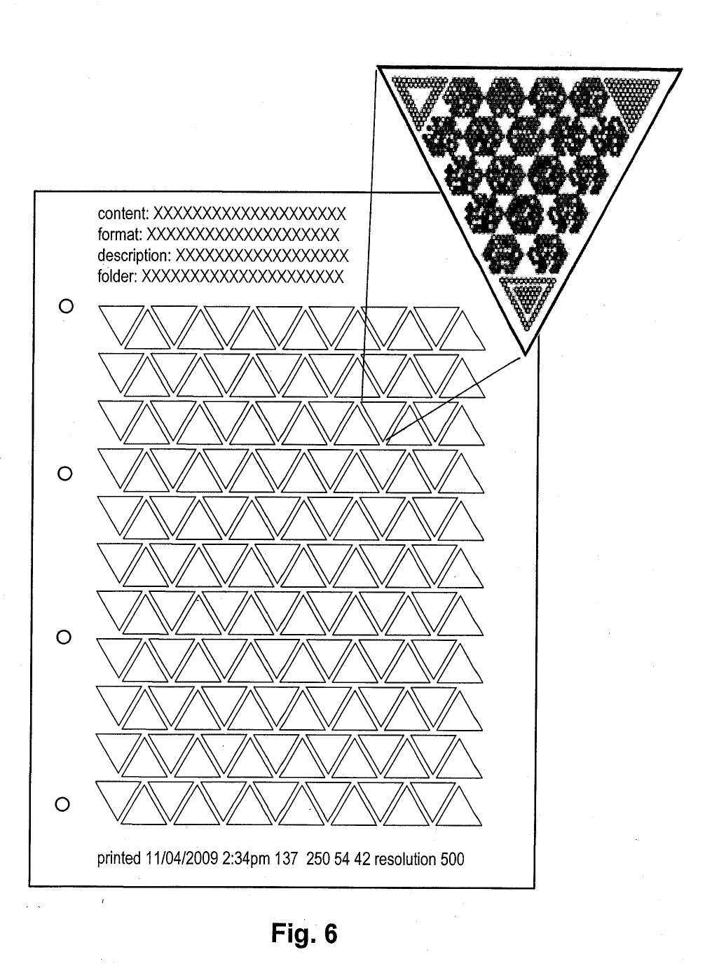

FIG. 6 is a sketch of a third sample of stored data as printed dot patterns in another, here a triangular configuration whereby each of the triangular patterns consists of an arrangement of hexagonal bit patterns containing the archived data, shown in the right part of FIG. 6 as enlargement of a single triangle. The cleartext on top of the sheet may again define the contents of the archived data below and/or the place where this page is to be stored. It may also contain further human readable information, e.g. place, time, and date of archiving, name or initials of the author and/or of the archivist.

In a variant of the embodiment shown in FIG. 6, the dot arrays are arranged hexagonally. These arrays comprise a large number of subarrays arranged close to each other. The subarrays are equilateral triangles and are placed in parallel rows, the subarray triangles being alternatingly opposed and interlaced in such a manner that always two rows form a stripe. This results in a rather high storage density. In this example each triangular subarray consists of 18 pixel patterns forming a hexagon; each dot is hexagonal too. One or more dots are combined into individual patterns which are correlated with the characters of the original document.

The dots may be of different colors. The data are printed by using a large number, e.g. 64, different inks which differ by their absorption or emission spectral patterns, such as the presence and frequency of spectral lines. By this, a correspondingly large number of bits can be written into one pixel. The individual colors are later read by using corresponding optical filters for illumination or for imaging of the pixels. The corner markers show different patterns to allow the software to recognize the orientation of the triangle and therefore the right decoding of the bit sequence.

In yet another variant of any of the above embodiments, the dots are written with magnetic ink, so that an additional readout by magnetic imaging is possible. Again, if several inks with different colors and/or different magnetic properties, e.g. different remanences or coercive fields, are used, the number of bits per dot and therefore the storage density can be increased.

To summarize, FIGS. 3 to 6 show sample sketches of archived data in various forms or patterns, possibly in different colors. Whereas the three examples show printed dot patterns plus cleartext on paper or a similar storage medium, it should be understood that these—or essentially similar—patterns may be stored magnetically on a suitable magnetic data carrier. Also, such patterns may be stored holographically or by other methods. The main requirement of any useful data carrier or medium is its durability and the fact, that the printed information is machine-recognizable.

The reading step according to the invention includes, as already mentioned above, scanning the archived data with adequate resolution to obtain an image, i.e. a graphical representation of the printed dot patterns on a sheet of the archive. Such an image is then transferred and stored in a memory of a computer which allows further processing.

Please note that, as mentioned above, this stored image is just a picture or image of the printed or otherwise recorded pattern on the storage medium—at this stage of the reading process it has not been analyzed to reveal data that convey meaning. Such an image may be produced from any storage medium, e.g. a floppy disk or a magnetic tape, even an old-fashioned punchcard.

Please note also that the data pattern in the memory is not even recognized regarding its structure, i.e. it is unknown at this instance whether it is data at all, it is just a picture of “white” and “black” or colored dots. Also, at this instance, whether any of the dots represents a single bit or several bits. This evaluation is done in the now following initial recognition steps, executed by the computer to which the memory is connected.

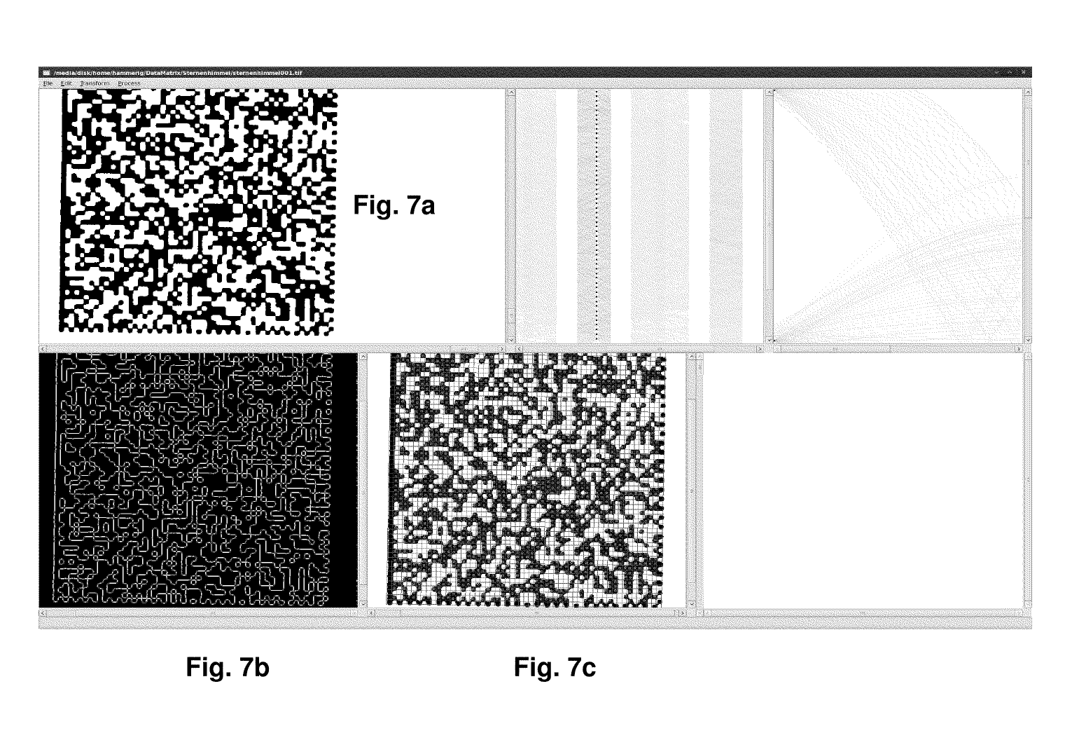

FIGS. 7a to 7c now show a screenshot of a proof-of-principle software program decoding a sample paper sheet as shown in FIG. 5. The object is to obtain a “bit picture” as prerequisite of the actual recognition process. FIG. 7a shows one separated bit pattern, which is subjected to a line detection algorithm using standard pattern recognition algorithms like the Sobel operation and Hough transformation as shown in FIG. 7b. Thus, the underlying grid of the data pattern is revealed. This grid is finally overlayed over the original data pattern thus allowing to read out the value of the individual bits. As the edges of the data pattern are different, the orientation of the data pattern, and therefore the bit sequence, can be restored.

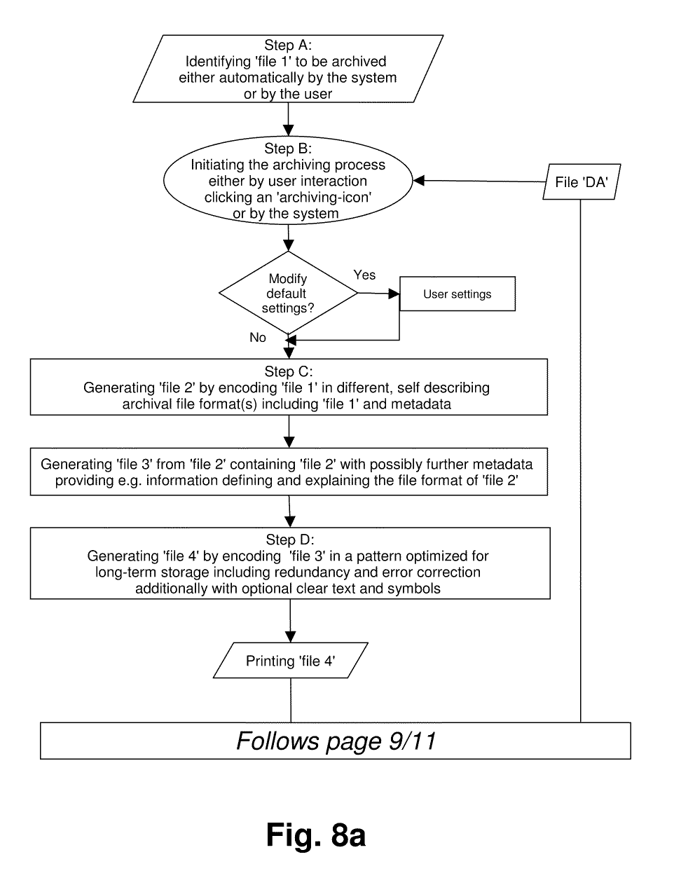

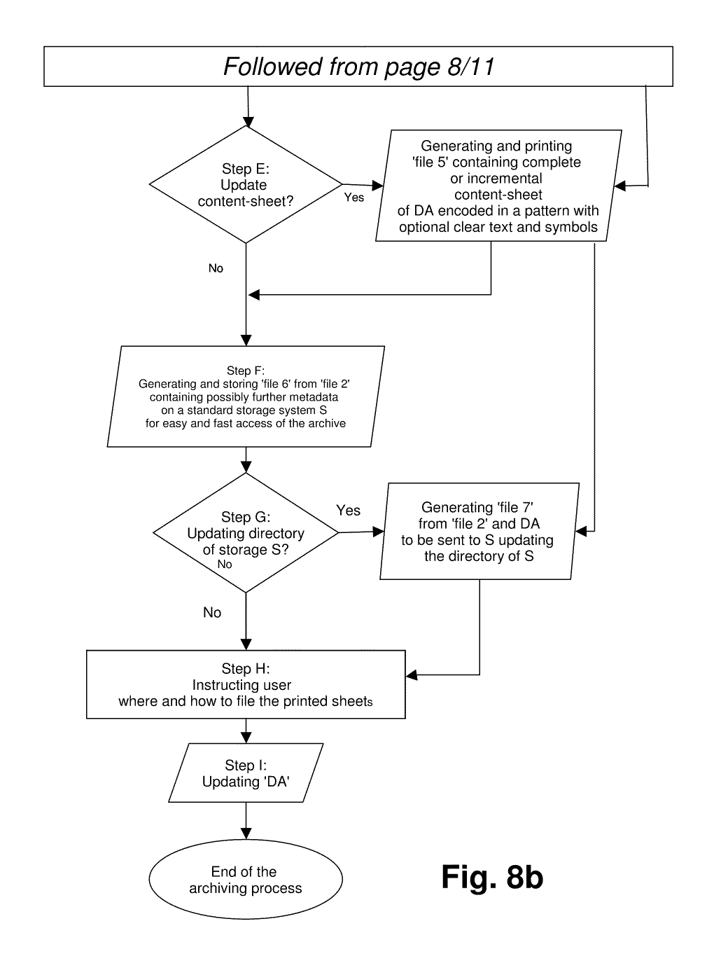

It should be clear that this recognition process is essentially independent of the size or resolution of the scan, which is the special advantage of the archival system disclosed. Further, the system does not require the use of special hardware, but operates with any scanning unit that fits to the used storing technique and provides adequate resolution. FIGS. 8a and 8b show a flow diagram of a possible implementation of the archiving process according to the invention. It should be noted that not all of the steps displayed in these two figures are necessary. It should also be noted that the process is usually implemented as a computer program or a component of the used operation system.

The first step, step A, is the identification of the data set or file to be archived: ‘file 1’. This can be done automatically, e.g. by a computer program that regularly, i.e. time-dependent, identifies with the help of predefined criteria data which are to be archived. Step A can as well be executed by the user, i.e. the user identifies the data to be archived, for example by marking the files in a file list or specifying files by a selection criteria. This file will here be called ‘file 1’. In the following the term ‘file’ may also refer to several files.

The next step, step B, is the actual initiation of the archiving process. One possibility is again an automatic initiation by the computer program. Also, the initiation can be done by user interaction, e.g. by clicking an “archiving icon” on the desktop of the computer, comparable to clicking on a printer icon of standard graphical user interfaces. Alternatively the algorithm may start the process by itself. If already archived data ‘DA’ exists, the information stored in ‘DA’ may also be taken into account for archiving ‘file 1’.

Anyway, the first decision now to be made is whether the default or preference settings for the archiving process are to be used or whether any modifications are necessary or meaningful. Any such modification will usually be entered by the user. However, depending on the nature of the data, an automatic modification may be possible, e.g. that any text data in a text data format such as MS Word or Lotus Word Pro are automatically transferred into pdf format.

In step C as shown in FIG. 8a, a ‘file 2’ is generated which includes encoded ‘file 1’ and selected metadata. The code or archiving algorithm uses file 1 as input, applying preference settings for the coding or generation, resp. As mentioned above, the preference settings may be given by a default setting, but may be modified or chosen by the user. According to the preference settings, the algorithm may also prompt the user for additional inputs during the archiving process.

The metadata may include additional information, e.g. when a photograph is to be archived, the technical data like camera settings, date/time, location, etc.

Other metadata to be archived may include
file name and size
file content
information on the file format
information concerning the code used to generate the dot-pattern
information on the history of the file, such as its data of generation, author, date of archiving, history of modifications
information on the archiving process
the name of its owner
time and date of archiving
software and hardware used to generate and archive the file.

The format of file 2 is preferably chosen such that the content of the file can be easily interpreted after retrieval. Its encoding should therefore be defined by simple and well specified and documented rules. An example of a favorable format is a general, self-describing markup language such as XML, but other existing well-documented formats such as PDF or PDF-A will also work.

Also, file 2 may consist of several files in which file 1 is encoded in different formats, and may also include file 1 in its original format.

Thus, in the first part of step C, ‘file 2’ is created.

Subsequently, still in step C, ‘file 3’ is generated, comprising ‘file 2’ and further metadata, the latter in particular including information defining and/or explaining the file format (or coding) of ‘file 2’ as metadata.

The main reason for adding these metadata is to ease the access to and the reading of the archived ‘file 2’. This is because the metadata are to be encoded in a very easily accessible format, such as ASCII or unicode text. Therefore, by using the information provided by these readily readable metadata, the reader will be able to identify the format of ‘file 2’ without actually having to open and read it. The latter may be difficult if the format of ‘file 2’ is unknown to the reader.

In step D, the completing generation step, ‘file 4’ is generated which is then printed onto the data carrier.

The term “printing” is used here in a very general sense, referring to the process of transferring the data onto a storage medium. ‘File 4’ contains all data to be archived, including the encoded printing information; it may also include clear text or other symbols to be printed.

The encoding of ‘file 4’ is preferably done such that the file format is optimized for storage with error correction including suitable redundancy, as for example specified by the preference settings. So may the data be printed several times, e.g., twice, spatially distributed in a manner that each copy is placed in a different area of the storage medium. A particularly advantageous encoding is based on encoding in ‘file 4’ each individual character of ‘file 3’ as block of bits which block, in the printing process, is treated and packed as one unit. Further, error correction codes, such as a Hamming code may be applied with advantage. The format of ‘file 4’ is chosen such that the bit sequence of the stored data will be easily detectable in the reading step.

The above-described plurality of generation steps can be combined into a smaller number of steps, even into one single step. One may, for example, generate a ‘file 2a’ (not shown in the figure) with all the metadata necessary for later recognition.

With printing ‘file 4’, the archival process is completed. Simultaneously, a new archive ‘DA’ is generated or ‘DA’ is updated, and a content page ‘file 5’ is generated or updated to keep track of ‘DA’.

In order to access the archived data faster and in a more comfortable way, one may also store the data on a fast and easy accessible storage medium called ‘S’. Therefore in step F, the algorithm generates from ‘file 2’ another file called ‘file 6’. This file contains ‘file 2’ plus further metadata that provide for example information defining and explaining the file format of ‘file 2’. ‘File 6’ is sent to a standard storage system such as a harddisk, a RAID-system, or a DVD. ‘File 6’ can be accessed much faster than ‘file 4’ which is printed on the storage medium and will be used, if the original data is lost or ‘S’ is not accessible any more.

In step G, similar to step E, the algorithm may generate from ‘file 2’ and data ‘DA’ yet another file, called ‘file 7’. This file may be sent to the to the standard storage system to update its directory. If the user utilizes a filing system to file the storage media, such as a lever arch file, the computer instructs the user in step H where or how to file the printed media.

In step I, the data ‘DA’ are updated to include the information that ‘file 1’ was successfully archived at this date, information about the location where the storage medium is stored, and that the directory has been updated. This update allows the software to keep accurate track of the status of the archived files and of files to be archived and thus assists the user.

So much for a general layout of the processes according to the invention. In the following, three embodiments of the method and the system according to the invention are described.

### First Embodiment

### Writing

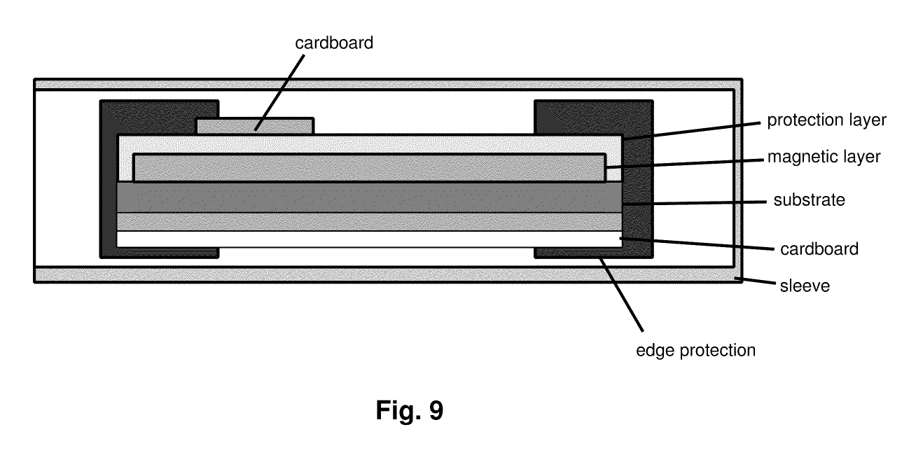

In the following, an embodiment of the invention is described that by a single mouse click archives data with a personal computer. A letter is taken as an example for a document to be archived. The letter was written with a text processor and formatted as a ‘doc’ file. ‘File 1’ of FIG. 8a is an example. The storage medium is a “hardsheet” shown in FIG. 9, described below. The archived pattern is as shown in FIG. 3, explained in detail above.

A clickable “archive” button, like standard “print” button, is implemented into the graphical user interface of the operating system and also into the user interface of the text processor.

A click on the button starts the archiving process of the letter as currently opened in the word processor; see steps A and B in FIG. 8a above.

Next, in step C, the archiving system collects the metadata of the ‘doc’ file stored and provided by the operating system. The archiving system stores all metadata in its memory or writes them into a text file, named ‘file 1m’. The metadata comprise name and size of the file, the name of its owner, a write-protection flag, and the file history. As given by preference setting, ‘file 1’ and ‘file 1m’ are encoded into an XML file, named ‘file 1a’, a pdf file, named ‘file 1b’, a file, named ‘file 1c’, containing the characters of the letter as unicode, and as a bmp-image file, named ‘file 1d’. All files are generated and named such that the files clearly identify which part of their contents refer to ‘file 1’ directly and which refer to file ‘1m’. Files 1, 1m, 1a, 1b, 1c together are henceforth referred to as ‘file 2’.

The archiving system now generates another text file, ‘file 2m’. As defined by given preference settings, ‘file 2m’ contains the following data:
a description of the code including error correction that will be used in step D, see FIG. 8a, to generate ‘file 4’;
descriptions of the ‘doc’ format and the XML format used or links to the descriptions of the formats used;
an fraud-resistant time stamp of the archiving time;
the name of person archiving;
the name of the computer on which the file was stored and archived;
the names and versions of operating system, text processor, archiving system, and of all other software used in the archiving process, such as the version of the pdf writer; and
optional metadata given by the user in a description field.

‘File 2’ and ‘file 2m’ together form ‘file 3’, see FIG. 8a.

Now the archiving system generates ‘file 4’ from ‘file 3’. ‘File 4’ presents a dot pattern that contains all data of ‘file 3’ including error correction and/or redundancy, and clear unicode text to be written in alphanumeric symbols.

As defined by given preferences, the dot pattern consist of n, here 2000, rectangular arrays of fields, each p dots and q dots wide, here p=q=1000. Arrays 1-10 contain the data of ‘file 2 m’, arrays 11-50 the data of ‘file 1’, etc. These arrays are sketched in FIG. 3 to 5, for clarity drawn with much smaller values of n, p, and q.

As defined by the preference settings, the encoding is done by a simple translation of the unicode number of a character into its 16-bit equivalent, adding 8 bits of error correction. This encoding insures that even if some characters should become unreadable, all other text remains decodable and unscathed.

While all information is already encoded in, say, 2000 arrays, to provide redundancy, each array is generated several times. In the example, each array is produced twice and will later be written onto two spatially well separated parts of a storage medium, e.g. a hardsheet shown in FIG. 9.

The clear text of ‘file 4’ contains all information to be written in alphanumeric symbols onto the hardsheet as described below.

Now ‘file 4’ is sent to the hardsheet writer which transfers the information as magnetic pixels into the magnetic layer of one or more hardsheets, shown in FIG. 9, and also prints the characters by inkjet-printing onto the cardboard of this hardsheet.

FIG. 9 shows a sketch of an exemplary hardsheet. It has a rectangular shape with rounded corners, say 15 cm wide, 20 cm long, and 0.5 mm thick. It consists of an ˜0.5 mm thick Ti or Al-alloy plate used as substrate. Oxide materials, such as Al₂O₃ or SiO₂, or other robust materials such as Teflon or Kapton, may be used as well. On this plate, a layer of a magnetic material with a large coercive field and a large magnetic energy density is grown by a standard film growth process, such as sputter deposition or electron-beam evaporation or buried by a standard implantation process. A typical thickness of this layer is 500 nm. While magnetic oxides such as Fe₃O₄ provide the specific advantage of outstanding chemical stability even under oxidizing conditions, this layer may also consist of non-oxide materials, such as a Co—Pt alloy. To seal and protect this layer, its surface and edges are covered by a 100 nm thick Al₂O₃ protection layer, grown by standard film growth process like sputter deposition. The back side of the substrate is covered by a mu-metal sheet that shields the magnetic layer from external magnetic fields and by a white, acid-free cardboard. The edges of the plate are covered by a plastic frame which prevents unintended damages to and by the sheets.

The hardsheet will carry the bit information, the bits being given by magnetized pixels with sizes of 5 μm*5 μm*500 nm. The material of the magnetic layer, its microstructure and the size of the pixels is chosen such that these pixels are stable over centuries under standard storage conditions. Due to this stability, the information content of the plate will even withstand conditions that are usually harmful for magnetic data carriers such as heat, electromagnetic pulses, or stray magnetic fields. Specifically, the large coercive force of the magnetic layer prevents the pixels from flipping in stray fields, and the magnetic energy of a pixel, e.g. several eV for SmCO₅, is orders of magnitude larger, usually by a factor of >100, than the thermal energy kT at 300 K. Likewise, the effective pinning energy of magnetic domain walls far exceeds kT. The enhancement of magnetic stability is acquired on cost of the storage density, ease of writing and writing speed. However, as data archiving faces different requirements than standard data storage, this is no drawback.

Because the magnetic layer is designed such that it is close to impossible to change the magnetization of the bits at room temperature, the hardsheet writer uses a write head working by thermally assisted recording, see, e.g. K. Matsumoto et al., Thermally Assisted Recording, Fujitsu Sci. Tech. J., 42, p. 158-167 (2006). For the time needed to write a bit, the magnetic layer is locally heated by a laser beam to a temperature above 500° C. At this temperature, the coercive field is weakened, so that the magnetic field of the write head can magnetize the bit. After cooldown, the bit is highly stable, of course.

It is noted that instead of a single magnetic write head, an array of heads may simultaneously be scanned across the hardsheet surface. Thereby, several magnetic pixels can be written in parallel, yielding a corresponding increase in writing speed.

The hardsheet writer writes the magnetization pattern corresponding to ‘file 4’, see FIG. 8a, into the hardsheet. It also writes as magnetic patterns the clear text according to ‘file 3’ into the hardsheet as standard unicode characters. It additionally prints the clear text as standard unicode characters with an inkjet writer onto a part of the top side of the substrate that carries an acid-free paper or directly onto the protection layer which is preferably writable by an inkjet printer. The back side of the hardsheet is covered by a cardboard or a plastic foil, onto which the user can write any desired text. If defined in the preferences, the archiving system generates multiple copies of the hardsheet for storage at different places.

The hardsheet is accompanied by a sleeve into which it can be slipped so that it can be handled safely and also stored in a filing system such as a lever arch file. The latter may be constructed using metal and mu-metal shielding plates to provide additional shielding. This sleeve may also have an optional open side covered by a shutter that can automatically be opened for reading by a mechanical action of the reading device.

The archiving system finally updates a database run in the PC which keeps tracks of all archived files, in particular the location of the datasheets. It also instructs the user in which folder and in which place to store the hardsheet. The archiving system may also generate a hardsheet which contains a directory of the archived files and their storage location, to be also filed by the user in the lever-arch file. Also, if hardsheets get lost or are dumped by the user, the software offers the possibility to update the database.

### First Embodiment

### Reading

To read the archived files, the user places the hardsheet onto an appropriate reader, e.g. a hardsheet reader-writer connected to a PC and clicks on a “read-from-archive button” on the graphical user interface of the PC operating system or directly presses a reading button mounted at the reader. This reader can be built using available standard parts and must essentially provide only adequate resolution to resolve the data pattern. Upon this command, the magnetic read head of the reader-writer is scanned across the surface of the hardsheet so that the resulting signals sent to the PC provide a non-interpreted magnetic image of the hardsheet with a spatial resolution of at least 200 nm in the example. During the scan of the first few lines, the scanner recognizes the smallest size of the information, especially if a calibration pattern is printed on the hardsheet, and adopt its resolution to this size. This will increase the scanning time as oversampling can be avoided. However, oversampling may explicitly be desired in order to enhance the pattern recognition process.

It is noted that instead of one magnetic field sensor, an array of magnetic read heads may be scanned simultaneously across the hardsheet surface. Thus several magnetic pixels can be read in parallel, yielding a corresponding increase in reading speed. A preferable way is to use a large array of Hall sensors as magnetic field detectors which are coupled on-chip to their readout electronics. In this case, many thousands of sensors may be operated in parallel with a concomitant enhancement of reading speed. Integrating the Hall sensors on-chip in a two-dimensional array and coupling these sensors directly to on-chip readout electronics, millions of sensors can be implemented and therefore millions of pixels can be read simultaneously. The data rate is even enhanced further if several of such chips are used in parallel.

To avoid any damage to the hardsheet during the scan, the topography coordinates of the hardsheet are measured, preferably by a contact-free optical method. These coordinates are then used to control the z-position of the read-head, so that it does not scratch the hardsheet. Due to this method also bent and warped datasheets can be read. Furthermore, this method also enables the archiving program to read hardsheets of different sizes or even pieces of broken datasheets.

While as magnetic field sensor of the hardsheet reader-writer a standard read head as used in modern hard drives may be used, one may also use as a contact-free sensor a magnetically sensitive microscope coupled to a CCD camera, which for example uses the Faraday effect or the Kerr effect.

It is noted that such a hardsheet reader-writer, if needed with an enhanced resolution, is also capable to easily read the magnetization images of “standard” circular shaped diskettes used in the past. It may also easily be equipped with a tape-feed so that it will be able to handle and image magnetic tapes of almost any format.

In the next step, the archiving system analyzes the magnetic image by using pattern recognition routines. A pattern recognition algorithm recognizes the magnetically written unicode characters and decodes them by character recognition. It also recognizes the presence of the dot arrays and further the information on the coding used and the instructions concerning the sequence in which the arrays are to be read. Taking advantage of this guidance information on the encoding and the pattern recognition, the software identifies the bitstream stored in the patterns and identifies the data within the bitstream by using the format read or given by the user. This was described above in connection with FIGS. 7a to 7c. Thus the original ‘file 4’ and its metadata will be restored. Then the metadata ‘file 3’, ‘file 2’, and even ‘file 1’ are read, the latter presenting the letter itself. Subsequently, these files are decoded and presented on the computer display and stored at a desired location, e.g., in the PC memory.

Furthermore, by taking advantage of the error correction used in coding the data on the hardsheet, the archiving system identifies the number of wrong or unreadable bits within the bitstream and, as specified in the preferences, informs the user about the condition of the hardsheet.

In an extension of this embodiment, the hardsheets are encoded such that they can only be decoded if multiple, say two, hardsheets are read by the hardsheet reader-writer, thus allowing the protection of sensitive data.

An important advantage of the invention as compared to standard magnetic storage becomes obvious here. In conventional magnetic disks, the lateral position of the write head and of the read head must be well matched, i.e. the read head must be placed exactly over the written track. Otherwise the data cannot be read. Accordingly, to read data on another track, the head has to be shifted in radial direction by exactly the same amount the write head exerted upon writing. Should the read head not be positioned precisely, the data cannot be read at all or only erroneaously. Storing the data according to the invention allows precise reading all bits independent of their precise position on the hardsheet, because a complete magnetic image of a large hardsheet area is acquired that “automatically” contains all data bits. The value of each bit is then easily identified by the pattern recognition process described. The decoding process does not take place in the reading device, but in the computer. As computers will be able to execute pattern recognition much more effectively in the future, the probability of reading a storage media correctly will increase in time and not decrease as observed with todays storage media.

It is furthermore noted that due to the power of the imaging of the data carrier and the pattern recognition process, the software of the archiving system can be written such that also files written on old data carriers such as the ones mentioned, e.g. diskettes or magnetic tapes can be read and decoded.

### Second Embodiment

The second embodiment of the invention differs from the first in such that the files to be archived are saved in two different ways, using only commonly available and affordable hardware.

The hardware of the archival system is provided by a printer/scanner unit. Much as described in the first embodiment, the archiving system generates a file presenting optional clear text and arrays of pixels, representing ‘file 4’ in FIG. 8a, most importantly also the instructions for decoding the data. This file is then sent to a high-resolution printer, such as a laser printer or an inkjet printer. This printer can be a commonly available consumer device, but may also consist of special designed hardware with optimized features and technical specifications to meet the needs for high density printouts and long term stabilized toner/ink.

The printer prints the data as dot patterns on a non-degradable carrier, such as a plastic foil or even standard, high-quality paper, which preferably is acid-free and possibly non-flammable. Special paper with an advanced coating may be helpful for a better sticking of the toner if laser printers are used. In case of inkjet printers the paper should have a fine granularity of the individual wood fibers to minimize the effect of ink bleeding. The use of very thin paper will be advantageous to minimize the amount of space needed to store the paper printouts in folders and shelves.

With this method, more than 10⁶ bytes can be stored on an A4 page, in particular if colors as used. Because the data are arranged in dot patterns which can vary in size and can be freely arranged, no specific requirement for the format of the paper sheet is needed. The user may choose any paper format she wants. The method will work therefore with any sheet sizes or formats. The potential of printing to store data has for example been disclosed in “Ultrahigh-Density Data Storage with Long Time Stability” J. Mannhart, J. Hilgenkamp, and B. Mayer, IBM Technical Disclosure Bulletin, Vol. 39, No. 10, 15-16 (1996). An example of such a printout is given in FIG. 5.

Printing the data with visible ink has the advantage that the data's state of preservation can be easily checked with the bare eye. Reading the data is easily done using an appropriate scanner or a digital camera with a high-resolution objective lens. Guidance patterns printed near the arrays guarantee that the information is read correctly although the carrier is scanned off-axis or upside down. The decoding employs again pattern recognition to recognize the location and format of the data arrays and the text printed in clear unicode characters. The archiving system reads or recognizes the guidance information for the decoding and decodes the data accordingly.

FIG. 5 illustrates an example for an archived dataset. Another advantage of this technique is that the data are completely robust against electromagnetic fields, such as created by electromagnetic pulses (EMPs). Partially damaged carriers still can be read, because all information is redundantly printed several times on different areas. The overall advantage however is the use of state of the art printing and scanning devices making the archival process affordable.

FIGS. 7a and 7b, already discussed above, show PC screenshot of a proof-of-principle software program that reads the pattern from a scanner and recognizes the pattern structure by using well documented standard pattern recognition algorithms. The pattern recognition process is essentially independent of the size or resolution of the scan which presents a significant cost advantage of this archival system since it does not require the use of special hardware, but operates with any scanning unit that provides adequate resolution.

As the format can be chosen freely, the method is not only restricted to sheets. In a variant of this method, the data are not printed on sheets, but rather on tapes. Due their large surface areas, these have the obvious advantage of a huge data storage capacity. In writing and reading, the tapes are spooled to pass the print-heads or the camera/scanning unit. The storing of such tapes build in containers or cassettes is well established and they are therefore easy to handle.

In another variant of this embodiment, see FIG. 6, addressed above, the data are printed by using a large number, e.g. 64, different inks which differ by their absorption or emission spectral patterns, such as the presence and frequency of spectral lines. By this, a correspondingly large number of bits can be written into one pixel. The individual colors are later read by using corresponding optical filters for illumination or for imaging of the pixels.

In yet another variant of this embodiment, the data are written with magnetic ink, so that an additional readout by magnetic imaging is possible. Again, if several inks with different colors and/or different magnetic properties, e.g. different remanences or coercive fields, are used, the number of bits per pixel and therefore the storage density can be increased.

Magnetic and visible ink can also be used as two methods to print data on a single sheet of paper. With the magnetic ink the data itself is printed in patterns, whereas the visible ink is used to print information readable by the eye for decoding the magnetic information. As the visible ink and the magnetic ink do not influence each other, both can be printed on top of each other, thereby using the available space in an optimized way.

As in the first embodiment, again new index page(s) or incremental index page(s) are generated automatically by the system serving as a fast readable and reliable table of content of all archived data.

The archival system is accompanied by a backup system like a standard long-term memory of a computer, such as RAID system or a simple harddisk/CD/DVD solution storing the same data for faster access. This data has not necessarily to be encoded in order to keep the access rates high. This system is used by the user for fast backup and reading of the archived data. The archival system may just come into play if the backup system fails in any way. Again, in order to synchronize the archival system and the backup system, in case, archived information is dumped, the backup system can be updated.

### Third Embodiment

In many cases it is required that data are written error-free onto a storage medium and that the stored data are stable against large electromagnetic pulses (EMPs). The latter may occur, e.g. due to lightning strikes or may be generated by military weapons. These requirements are easily met by the invention, as is illustrated by the third embodiment.

In this embodiment, the archiving of the data is done using a phase-change material as data carrier. It is well known that in materials such as Ge₂Sb₂Teₛ₅ several phases can be induced by heating the materials and cooling them in a controlled manner. If Ge₂Sb₂Te₅ is heated to 550° C. and then cooled, for example, it forms a metallic, conducting phase if cooled slowly, e.g. cooling time >1 μs, but an amorphous, non-conducting phase if it is quenched, i.e. cooled very quickly. Such materials and the phase change processes are described, for example, in S. Raoux et al., Phase-change Random Access Memory: a Scalable Technology, IBM J. Res. & Dev., Vol. 52, 465 (2008).

These hardsheets have designs comparable to the ones used for magnetic writing shown in FIG. 9, except that no mu-metal shield is desired and the magnetic material is replaced by a layer of a phase change material.

Hardsheets of these materials are built as essentially described in FIG. 9. A layer of Ge₂Sb₂Te₅ that act as phase-change material is grown by sputter deposition or by electron beam evaporation on a carrier sheet that consists of a 100 nm thick MgO layer grown by reactive sputtering on a 0.1 mm thick stainless steel sheet. The Ge₂Sb₂Te₅ layer is sealed by a 100 nm thick film of Al₂O₃, also grown by sputtering.

To archive the data, a single-click process as described in the first embodiment is started. The data are then written into the phase-change hardsheet by local heating a pixel with a pulse of a focused light beam, preferably a focused laser beam which is scanned across the hardsheet surface. Preferably, however, the laser beam is kept fixed in space and the hardsheet is scanned under the laser beam. This configuration has the advantage that all optical components can be operated and aligned for a fixed position and therefore do not need to be scanned. Thereby it is also easily possible to write by using several laser beams, say 100, operated in parallel, so that the writing speed is enhanced. The turn-off profile of the pulse is chosen to control the bit content of the pixel. A fast turn-off ramp will cause the pixel to be insulating corresponding, e.g. to a logical 0, a slow ramp will generate a conducting pixel corresponding, e.g. to a logical 1. The size of a pixel in the implementation under discussion is 5 μm*5 μm.

The logic format of the written data corresponds to the one elucidated in the first embodiment. Also, as described there, besides the data written as bits and pixels, unicode text is preferably written onto the hardsheet, at best as unicode characters written into the phase change material, and, in addition, as printed text that is visible to the eye.

The readout is done by exciting the plate with a constant or a time-varying electric field, a magnetic field, or an electromagnetic field and measuring the response caused by the conductivity difference of the bits that encode logic “1s” and “0s”, respectively. The excitation and/or the measurement may be done locally. For example, eddy currents may locally be generated in the hardsheet by exciting the hardsheet with an electromagnetic AC field, e.g. with a frequency of 1 MHz, as generated by a current sent through a small, integrated coil that is scanned over the hardsheet. A second small coil, a pick-up coil, connected to an amplifier serves to measure the AC field generated by the hardsheet responding to this excitation. If a pixel is conducting, the ac field generate large local currents which then induce a large signal in the pick-up coil. As a result of the scan, a conductance picture of the hardsheet is generated by the archiving system, which then is analyzed by the pattern recognition process using for the decoding the guidance information provided by the metadata. For the scanning, several pick-up loops, say 100, are preferably installed and operated in parallel, using the parallelicity to enhance the reading speed.

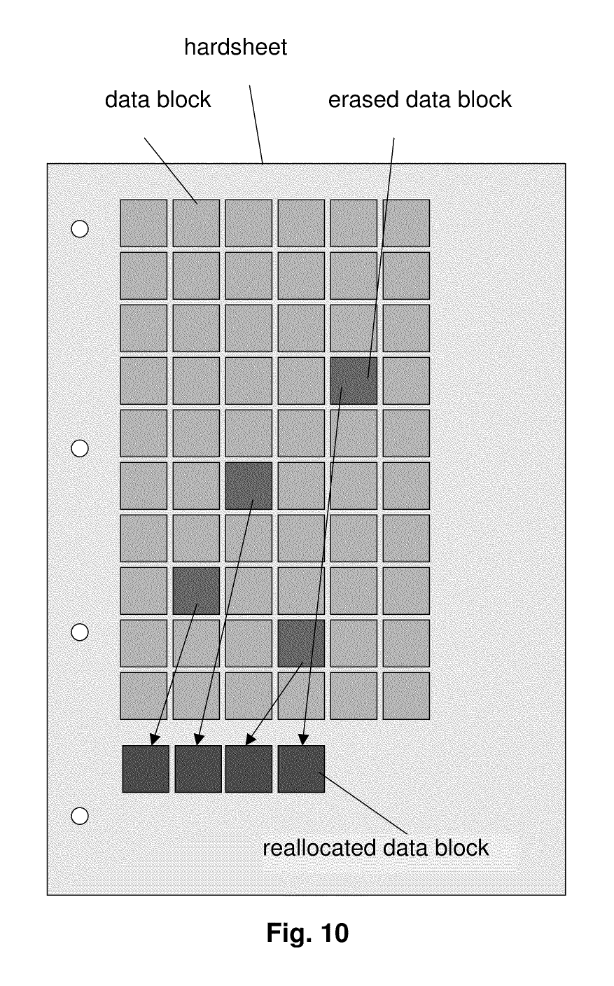

In the implementation presented, emphasis is put on utmost accuracy of the written data. Therefore, after writing a bit pattern into the harddisk, the disk is completely read out to check for corrupted bits. If such bits should be found, they are written again and once more checked. Should again they have failed, the data block of which they are part of is moved to another, unused area of the hardsheet, see FIG. 10. This block is then verified again as described, the old block is erased. Due to the relocation of the data block, the original sequence of the data blocks is altered. Therefore the algorithm also erases the status information on the hardsheet that described the original sequence of the data blocks and then writes a new set of metadata that reflect the new sequence of the data blocks onto the hardsheet. It is apparent that this procedure of verifying written data may also be done in the same or a similar manner in the other implementations of the invention described.

A prominent advantage of this kind of hardsheet is the fact that it is robust again electromagnetic disturbances, such as electromagnetic pulses because the written bits or dots are not altered by magnetic or by electric fields. Therefore the archived data are also stable against large background magnetic fields, even for prolonged exposure. Thus, they are not altered, if for example, strong magnets are brought into the vicinity of the datasheets, which may happen accidentally. Such stability is, for example, also desirable for applications in space. In many satellites, data need to be stored safely, and these need to be stable even if imposed to the electromagnetic environment present in space, e.g. by radiation belts, or on-board of the spacecraft.

Because the datasheets are highly resistant against corrosion, they are also preferable storage media for other applications, in which data need to be stored decades in chemically challenging requirements. The datasheets revealed in this embodiment will not even corrode in contact with seawater. The embodiment presented is therefore a preferable solution to store data in black-boxes of aircrafts or ships. Even if the datasheets should be immersed in seawater for decades, their data-content can easily be read once the plates are recovered.

1. A method for the automated digital archiving of data, comprising:
(1) a writing step in which
said data to be archived are identified,
a first algorithm is applied to said data, said first algorithm encoding said data into an encoded file
said encoded file is written into or onto a durable storage medium in a machine-recognizable, regularly arranged pattern with a predefined high density at least locally exceeding 5 kB/cm²,
(2) a reading step, in which
said storage medium is at least partially scanned to obtain an image, in particular a raster graphic, of said pattern,
said obtained image is transferred to and stored in a memory as an image,
said image in said memory is at least partially analyzed by a second algorithm employing pattern recognition to identify bits in said data pattern, to determine the value of said bits and their sequence, and to produce a bit stream for readout.

2. The method for the digital archiving of data according to claim 1, wherein:
the machine-recognizable pattern produced in the writing step encompasses two parts, a first part comprising the stored data and a second part comprising file format information describing the format of the stored data, and
in the reading step, said file format information is applied for decoding the bit stream to derive its content.

3. The method for the digital archiving of data according to claim 2, wherein the second part is stored in a human-readable pattern.

4. The method for the digital archiving of data according to claim 1, wherein the data to be archived are identified automatically, preferably following a protocol describing time and files to be backed-up.

5. The method for the digital archiving of data according to claim 1, wherein the durable storage medium has an expected lifetime exceeding 50 years.

6. The method for the digital archiving of data according to claim 1, wherein the image stored in the memory comprises the information of a predefined range of a large number of bits of said data pattern, preferably of at least ten bits of the data pattern, to enable the pattern recognition.

7. The method for the digital archiving of data according to claim 1, wherein the writing step includes writing the file as a regular bit pattern onto the durable storage medium using a redundancy and/or an error correction algorithm.

8. The method for the digital archiving of data according to claim 1, wherein the writing step comprises
applying at least two different first algorithms to the data, thus encoding said data into at least two differently encoded files and
writing each of said differently encoded files into or onto the durable storage medium as a regular bit pattern, thus providing a redundancy of the data to be archived.

9. The method for the digital archiving of data according to claim 8, wherein said differently encoded files are written as at least one regular bit pattern onto the durable storage medium using redundancy and/or error correction, thus providing a multiple redundancy of the data to be archived.

10. The method for the digital archiving of data according to claim 1, wherein the data to be archived include metadata, in particular metadata identifying the file name, size, content, format, code used, history, and/or information on the archiving process used.

11. The method for the digital archiving of data according to claim 1, wherein the first algorithm encodes the data in the writing step into an XML file or a PDF file.

12. The method for the digital archiving of data according to claim 1, wherein the reading step comprises:
evaluating the image stored in the memory by first applying an edge detection algorithm to said image to identify a transition pattern, developing a matching grid pattern from said transition pattern, overlaying said grid pattern over said stored data pattern, identifying the bits and their sequence and producing the bit stream.

13. The method for the digital archiving of data according to claim 1, wherein the writing step comprises:
writing the encoded file into or onto the storage medium in a machine-recognizable, regularly arranged pattern in a self-describing, corruption-safe format with a predefined high density at least locally exceeding 5 kB/cm².

14. A method for reading or reconstructing data from a data carrier, in particular a magnetic hard disc or a floppy disk, characterized by the following steps:
scanning said data carrier to create an image of said data,
transferring an image of at least a part of said data carrier in a memory,
analyzing said image to derive a bit pattern, and
reading said bit pattern to generate a bit stream representing said data on said data carrier.

15. The method for reading or reconstructing data according to claim 14, wherein the scanning step includes a successive or incremental sampling, preferably in a Carthesian coordinate system.

16. The method for reading or reconstructing data according to claim 14, wherein, when reconstructing data of a magnetic disk, the reading step includes interpreting the bit pattern according to a standard recording scheme for magnetic disks to generate the bit stream representing the data on said magnetic disk.

17. A system for the automated digital archiving of data, comprising:
a durable storage medium adapted to store a machine-recognizable, at least two-dimensional, regular bit pattern whose density at least locally exceeds 5 kB/cm²,
a writing assembly including
means for encoding the data identified to be archived by a first algorithm, creating an encoded file in a self-describing, corruption-safe format,
means for writing said encoded file into or onto said durable storage medium,
a reading assembly including
means for imaging said data pattern in said storage medium,
a memory for storing said data pattern,
means for analyzing said image stored in said memory by a second algorithm recognizing said data pattern, including means for identifying bits in said data pattern, for determining the value of said bits and their sequence, and for producing a bit stream as output.

18. The system for the automated digital archiving according to claim 17, wherein the durable storage medium comprises:
a magnetic layer on a substrate as data carrier and
a protection layer on said magnetic layer and, preferably,
an edge protection assembly covering at least part of the edge of said magnetic layer, said substrate, and said protection layer, and, preferably,
a sleeve, preferably of ferromagnetic material, enclosing all elements above.

19. The system for the automated digital archiving according to claim 17, wherein
the means for writing the encoded file into or onto the durable storage medium is a printer and
said durable storage medium is paper or a plastic film, especially a coated plastic film.

20. The system for the automated digital archiving according to claim 17, wherein the durable storage medium comprises:
a phase-change layer on a substrate as data carrier, preferably on an insulating intermediate layer,
a transparent protection layer on said phase-change layer, and
a laser beam assembly focusing a laser beam onto said phase-change layer for switching it locally between an insulating state and a conducting state.
